(19) United States
(12) Patent Application Publication
(10) Pub. No.: US 2007/0025205 A1
(43) Pub. Date: Feb. 1, 2007

(54) Optical pickup and optical recording and/or reproducing apparatus employing the same

(75) Inventors: Tae-kyung Kim, Seoul (KR); Jin-won Lee, Seongnam-si (KR); Kyong-tae Park, Yongin-si (KR); Woo-seok Choi, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/492,125

(22) Filed: Jul. 25, 2006

(30) Foreign Application Priority Data
Jul. 28, 2005 (KR) 2005-69141

(51) Int. Cl. G11B 7/00

(52) U.S. Cl. 369/44.24

(57) ABSTRACT

An optical pickup, including a light source, an objective lens to focus light emitted from the light source to form a light spot on an optical information storage medium, an optical path changer to change an optical path of the light, a photodetector to receive light reflected/diffracted by the optical information storage medium and to detect an information signal and/or an error signal, and an optical element preventing part disposed in a central region of the light, to prevent a part of the central region of the light, which is reflected/diffracted by the optical information storage medium and which propagates toward the photodetector, from being received by the photodetector.

### CROSS-REFERENCE TO RELATED APPLICATION

This application claims the benefit of Korean Patent Application No. 2005-69141, filed on Jul. 28, 2005, in the Korean Intellectual Property Office, the disclosure of which is incorporated herein in its entirety by reference

### BACKGROUND OF THE INVENTION

1. Field of the Invention

An aspect of the present invention relates to an optical pickup and an optical recording and/or reproducing apparatus employing the optical pickup, and, more particularly, to an optical pickup which prevents degradation of a focus error signal due to an adjacent track when recording and/or reproducing information to/from a land/groove information storage medium, and an optical recording and/or reproducing apparatus employing the optical pickup.

2. Description of the Related Art

Optical recording and/or reproducing apparatuses record information onto or reproduce information from an information storage medium (i.e., an optical disc), by focusing light on the information storage medium with an objective lens. Optical recording and/or reproducing apparatuses typically use an astigmatic method to detect a focus error signal during the focusing operation. Since the astigmatic method of detecting a focus error signal using astigmatism requires an astigmatic lens and a quadrant photodetector, the method has advantages of requiring a simple structure, relatively easy adjustment, and low costs.

In the case of groove-only information storage media, in which information is stored only in grooves of information storage media, general optical pickups detect a focus error signal using an astigmatic method. Meanwhile, in the case of land/groove information storage media, in which information is recorded in both lands and grooves of information storage media, it is difficult for general optical pickups to detect a focus error signal using the astigmatic method, which will be described later.

Groove-only information storage medium standards include a digital versatile disc-recordable/rewritable (DVD-R/RW) standard and a high-definition digital versatile disc (HD DVD) standard. Land/groove information storage medium standards include a digital versatile disc-random access memory (DVD-RAM) standard and a blu-ray disc (BD) standard. According to the HD DVD standard, the wavelength of a light source is 405 nm, the numerical aperture of an objective lens is 0.65, and the thickness of an optical disc is approximately 0.6 mm, like in the DVD standard. According to the BD standard, the wavelength of a light source is 405 nm, the numerical aperture of an objective lens is 0.85, and the thickness of an optical disc is approximately 0.1 mm.

FIG. 1A illustrates a view of a DVD-R/RW, which is a groove-only optical disc in which marks are recorded only on grooves G, having a track pitch of 0.74 um. FIG. 1 B illustrates a DVD-RAM with grooves G and lands L, each having a width of 0.615 um in which marks are recorded on both lands L and grooves G. As shown in FIG. 1 B, when the grooves G of the land/groove DVD-RAM have a depth equal to ⅙ of a wavelength, influence of an RF signal caused by an adjacent track may be reduced, thereby increasing density in a track direction. Accordingly, a track pitch of the DVD-RAM is almost doubled, making a detection of a high quality push-pull tracking error signal possible.

FIG. 2 illustrates the position of first order light diffracted by an optical disc relative to an exit pupil a of an objective lens when the radius of the exit pupil a is normalized to 1. The exit pupil a of the objective lens corresponds to zero^{th} order light reflected/diffracted by the optical disc. FIG. 3A illustrates an intensity distribution of light diffracted by the DVD-R/RW at the exit pupil of an objective lens. FIG. 3B illustrates an intensity distribution of light diffracted by the DVD-RAM at the exit pupil of an objective lens.

As shown in FIG. 2, when a track pitch (period) of the optical disc, that is, a distance between adjacent grooves is P, the wavelength of a light source is λ, the numerical aperture of the objective lens is NA, and the radius of the exit pupil a of the objective lens is normalized to 1, the center of the first order light diffracted by the optical disc is located at ±λ/(NA*P) from the center of the exit pupil a. Accordingly, as shown in FIG. 3A, in the case of the DVD-R/RW, the ±1 order light beams do not overlap each other in the center of the zero^{th} order light spot. On the other hand, as shown in FIG. 3B, in the case of the DVD-RAM, the −1 order light beams overlap each other in the center of the zero^{th} order light spot.

FIG. 4 is a plan view of a quadrant photodetector 1. As shown in FIG. 4, the quadrant photodetector 1 detects light reflected off of an optical disc with four light-receiving portions A, B, C, and D, and a focus error signal (FES), detected using an astigmatic method, is expressed by Equation 1. For convenience, the four light-receiving portions of the quadrant photodetector 1 and signals detected thereby are given the same reference characters.
FES=[(A+C)−(B+D)]/[(A+C)+(B+D)] (1).

FIGS. 5A and 5B are graphs illustrating focusing signals detected using an astigmatic method for a DVD-R/RW and a DVD-RAM, specifically illustrating S-curves (up-down signals) that are obtained when the objective lens is moved up and down and signals that are obtained when the focusing signals are locked. In FIGS. 5A and 5B, the horizontal axis with respect to the S-curve represents a distance between the objective lens and the optical disc and the vertical axis with respect to the S-curve represents a focus error signal.

As shown in FIGS. 5A and 5B, a greater disturbance occurs in the focus error signal for the DVD-RAM than for the DVD-R/RW because track information during track crossings affect the focusing signal. This effect is called focus crosstalk, which is generated because of region where the ±1 order light beams overlap each other as shown in FIG. 3B. Accordingly, when the track information is loaded to the focusing signal during the track crossings, a disturbance, namely, focus crosstalk, occurs, making detection of a stable focusing signal possible. In particular, as shown in FIG. 5B, in the case of the land/groove optical disc, it is difficult for a general optical pickup to detect a focus error signal using a general astigmatic method due to such focus crosstalk.

### SUMMARY OF THE INVENTION

Aspects of the present invention provide an optical pickup which detects a focus error signal using an astigmatic method even for a land/groove information storage medium, and an optical recording and/or reproducing apparatus employing the optical pickup.

According to an aspect of the present invention, there is provided an optical pickup, including a light source, an objective lens to focus light emitted from the light source to form a light spot on an optical information storage medium, an optical path changer to change an optical path of the light, a photodetector to receive light reflected/diffracted by the optical information storage medium and to detect an information signal and/or an error signal, and an optical element preventing part disposed in a central region of the light, to prevent a part of the central region of the light, which is reflected/diffracted by the optical information storage medium and which propagates toward the photodetector, from being received by the photodetector.

When a track pitch of the optical information storage medium, which is a distance between adjacent grooves, is P, the wavelength of light emitted from the light source is λ, the numerical aperture of the objective lens is NA, and the radius of an exit pupil of the objective lens is normalized to 1, the optical element may prevent the light which is reflected/diffracted by the optical information storage medium and which is located at a range of approximately ±(λ/(NA*P)−1) in a direction of the reflected/diffracted light from the optical information storage medium from being received by the photodetector.

The optical information storage medium may be one of first and second optical information storage media having different standards; information may be recorded on both lands and grooves of the first optical information storage medium and the track pitch of the first information storage medium may be P1, and information may be recorded only on grooves of the second optical information storage medium and the track pitch of the second information storage medium may be P2; and when P1>P2, the optical element may be formed to prevent light in a range of approximately ±(λ/(NA*P1)−1) from being received by the photodetector.

The optical element may have a diffraction region that diffracts light propagating toward the photodetector so that light in part of a central region of the light is deviated from the photodetector.

The optical pickup may further comprise a wave plate that is interposed between the optical element and the objective lens and changes the polarization of incident light, wherein the diffraction region of the optical element is a polarization diffraction region being polarization-dependent so that the incident light according to the polarization of the incident light transmits toward the optical information storage medium and light reflected by the optical information storage medium diffracts.

The optical pickup may further comprise: an astigmatic element interposed between the optical path changer and the photodetector to detect a focus error signal using an astigmatic method; and a focus error signal detecting portion to generate a focus error signal from a signal detected by the photodetector using the astigmatic method.

The photodetector may be a quadrant photodetector with four light-receiving portions arranged in a 2×2 matrix.

The optical element may prevent the part of the central portion of the light from being received by the photodetector by diffracting the part of the central portion of the light, and the optical pickup may further comprise: at least one auxiliary photodetector to receive the part of the central region of the light diffracted by the optical element; and a reproduction signal detecting portion to produce an information reproduction signal as a sum of a signal detected by the photodetector and a signal detected by the auxiliary photodetector.

According to another aspect of the present invention, there is provided an optical recording and/or reproducing apparatus comprising: the above-described optical pickup movable in a radial direction of an optical information storage medium to reproduce and/or record information from and/or onto the optical information storage medium; and a control unit to control the optical pickup.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates a view of a digital versatile disc-recordable/rewritable (DVD-R/RW) having a track pitch of 0.74 um;

FIG. 1B illustrates a view of a digital versatile disc-random access memory (DVD-RAM) having grooves and lands, each having a width of 0.615 um;

FIG. 2 illustrates the position of first order light diffracted by an optical disc relative to an exit pupil of an objective lens when the radius of the exit pupil of the objective lens is normalized to 1;

FIG. 3A illustrates an intensity distribution of light diffracted by the DVD-R/RW disc at the exit pupil of an objective lens;

FIG. 3B illustrates an intensity distribution of light diffracted by the DVD-RAM disc at the exit pupil of an objective lens;

FIG. 4 is a plan view of a quadrant photodetector;

FIGS. 5A and 5B are graphs illustrating focusing signals detected using an astigmatic method for a DVD-R/RW and a DVD-RAM, specifically illustrating S-curves (up-down signals) obtained when an objective lens is moved up and down and signals obtained when the focusing signals are locked;

FIG. 6 is an exploded perspective view of an optical pickup according to an embodiment of the present invention;

FIG. 7 is a plan view of the optical pickup of FIG. 6;

FIG. 8 illustrates an example of an optical element of the optical pickup of FIG. 6;

FIG. 9 illustrates a shape of a light received onto a photodetector when light of region where ±1 order light beams overlap each other is prevented by the optical element of FIG. 8;

FIG. 10 illustrates a signal operational circuit and a photodetector applicable to the optical pickup according to an embodiment of the present invention;

FIGS. 11 and 12 are graphs illustrating focusing signals detected by the optical pickup according to the present invention using an astigmatic method for a DVD-R/RW and a DVD-RAM, particularly illustrating S-curves (up-down signals) obtained when an objective lens is moved up and down and signals obtained when the focusing signals are locked; and

FIG. 13 illustrates an optical recording and/or reproducing apparatus employing an optical pickup according to an aspect of the present invention.

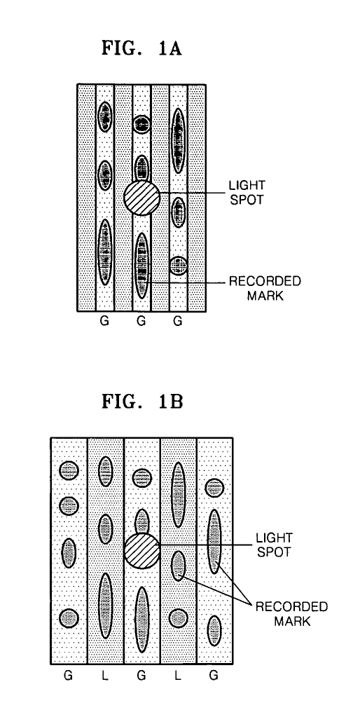

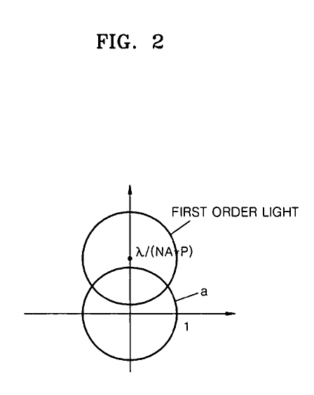

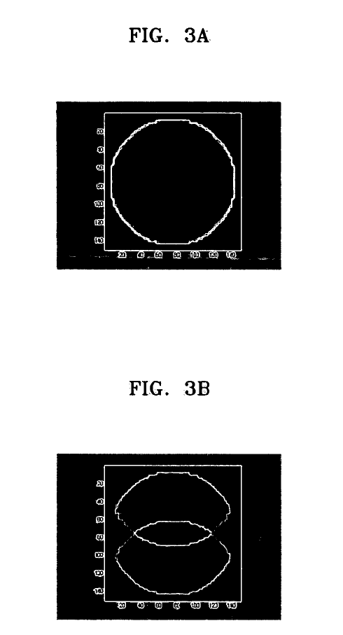

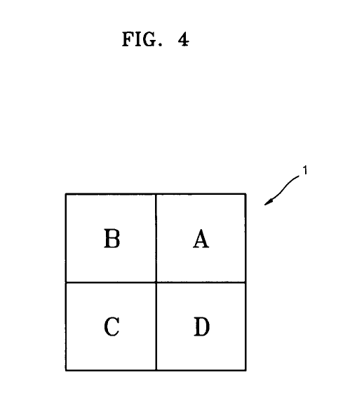

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An optical pickup, according to an aspect of the present invention, includes an optical configuration to detect a focus error signal using an astigmatic method even for a land/groove information storage medium, such as a digital versatile disc-random access memory (DVD-RAM) or a blu-ray disc (BD). Accordingly, the optical pickup, according to an aspect of the present invention, detects a focus error signal using an astigmatic method for both land/groove information storage media and groove-only information storage media.

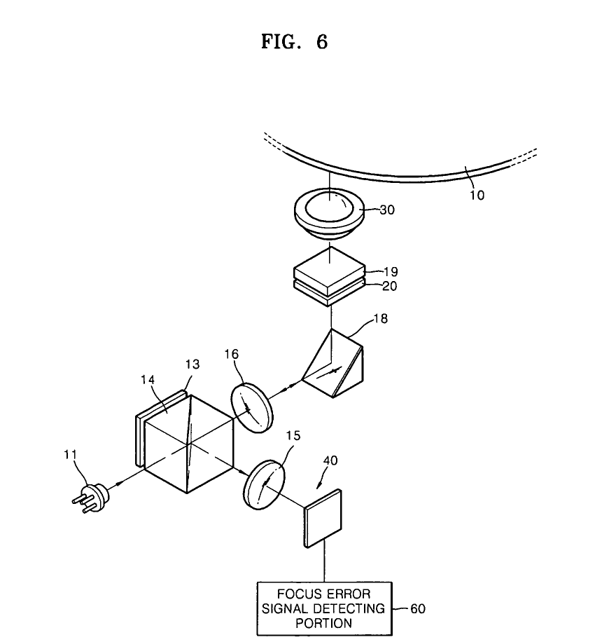

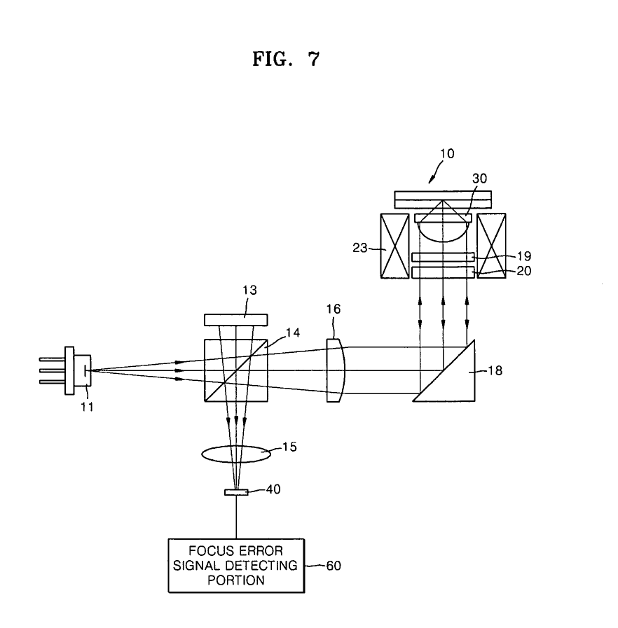

FIG. 6 is an exploded perspective view of an optical pickup according to an embodiment of the present invention. FIG. 7 is a plan view of the optical pickup of FIG. 6. As shown in FIGS. 6 and 7, the optical pickup includes a light source 11, an objective lens 30 to focus light emitted from the light source 11 to form a light spot on an optical information storage medium, that is, an optical disc 10, an optical path changer to change an optical path of incident light, a photodetector 40 to receive light reflected by the optical disc 10 and to detect an information signal and/or an error signal, and an optical element 20 to block part of a central region of light reflected/diffracted by the optical disc 10 and propagating toward the photodetector 40 from being received by the photodetector 40.

The optical pickup may further include a cylindrical lens 15 interposed between the optical path changer and the photodetector 40 to act as an astigmatic lens to generate astigmatism so that a focus error signal is detectable using an astigmatic method, as an optical element generating astigmatism. The optical pickup may further include a focus error signal detecting portion 60 to produce a focus error signal from a signal detected by the photodetector 40 using the astigmatic method.

As shown in FIGS. 6 and 7, a collimating lens 16 collimates divergent light emitted from the light source 11 such that the collimated light is incident on the objective lens 30. A reflective mirror 18 reflects incident light. The light source 11 emits light with a predetermined wavelength, e.g., red light with a wavelength of 650 nm, that is suitable for digital versatile disc-recordable/rewritable (DVD-R/RW) and DVD-RAM standards, or blue light with a wavelength of 405 nm that is suitable for BD and high-definition digital versatile disc (HD DVD) standards. The light source 11 may be a semiconductor laser. The objective lens 30 may have a numerical aperture of approximately 0.65 to satisfy the DVD standard, or a numerical aperture of approximately 0.85 to satisfy the BD standard. When the light source 11 emits red light and the objective lens 30 has a numerical aperture of 0.65, the optical pickup detects a focus error signal for a DVD-RAM and/or a DVD-R/RW using an astigmatic method.

Of course, it is understood that the wavelength of the light source 11 and the numerical aperture of the objective lens 30 may vary, and that the optical configuration of the optical pickup may also vary. For example, to be compatibly adapted for use with a BD and an HD DVD, the light source 11 may emit blue light with a wavelength of 405 nm. The objective lens may have effective numerical apertures suitable for both the BD and the HD DVD, or may have a numerical aperture of 0.85 suitable for the BD and a separate member included to adjust the effective numerical aperture.

Similarly, to be compatibly adapted for use with a BD, an HD DVD, and a DVD, the light source 11 may include a light source module emitting light with a plurality of wavelengths, for example, blue light suitable for high-density optical discs, such as the BD and the HD DVD, and red light suitable for the DVD. The objective lens 30 may have an effective numerical aperture suitable for the BD and the DVD, or a separate member included to adjust an effective numerical aperture.

The optical pickup may record and/or reproduce to and/or from high density optical discs such as BDs and HD DVDs by an optical configuration of FIG. 6, and may be arranged in further optical configurations to be able to record and/or reproduce to and/or from at least one of DVDs and CDs.

The optical element 20 is disposed on an optical path between the objective lens 30 and the photodetector 40. When the distance between adjacent grooves, that is, the track pitch, of the optical disc 10 is P, the wavelength of light emitted from the light source 11 is λ, the numerical aperture of the objective lens is NA, and the radius of an exit pupil of the objective lens 30 is normalized to 1, the optical element 20 is formed to prevent light, which is reflected/diffracted by the optical disc 10 and which is located in a range of approximately ±(λ/(NA*P)−1) along the direction of refleted/diffracted light from the optical disc 10, from being received by the photodetector 40.

In detail, when the track pitch of a land/groove optical disc in which information is recorded on both lands and grooves is P1, a track pitch of a groove-only optical disc in which information is recorded only on grooves is P2, and P1>P2, the optical element 20 may be formed to prevent light in a range of approximately ±(λ/(NA*P1)−1) from being received by the photodetector 40.

Thus, the optical element 20 prevents a situation in which a light region, in which ±1 order light beams reflected/diffracted by the land/groove optical disc overlap each other, from being received by the photodetector 40.

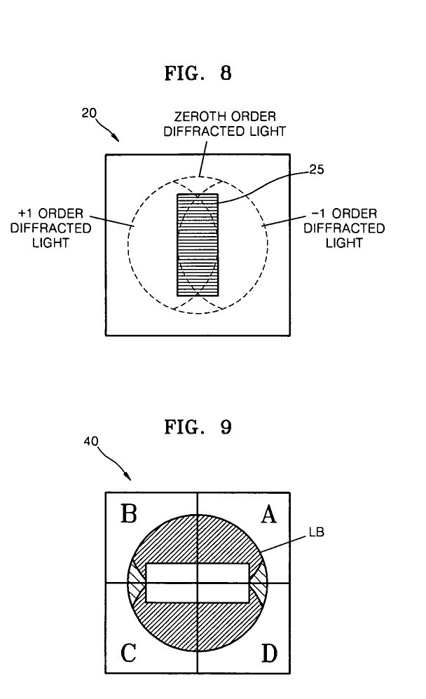

FIG. 8 illustrates an example of the optical element 20. As shown in FIG. 8, ±1 order light beams that are reflected/diffracted by the land/groove optical disc pass through the objective lens 30 and are incident on the optical element 20. Further, a region of the light beams overlap each other in the center of the zero^{th} order light spot. As shown in FIG. 8, the optical element 20 may have a diffraction region 25, for example, a hologram region, corresponding in size to that of the light region where the ±1 order light beams overlap each other to prevent light in this light region from being received by the photodetector 40. The diffraction region 25 diffracts the light region where the ±1 order light beams overlap each other such that light in the light region deviates from the photodetector 40.

Accordingly, light LB, with the light region where the ±1 order light beams overlap each other being blocked from the photodetector 40, is received by the photodetector 40, as shown in FIG. 9. FIG. 9 illustrates the shape of light that is blocked from the overlapped light region of ±1 order light beams by the optical element 20 of FIG. 8 and which is received by the photodetector 40.

The optical pickup may further include a wave plate, for example, a quarter wave plate 19 with respect to wavelength of light emitted from the light source 11, to change the polarization of light emitted from the light source 11. The diffraction region 25 of the optical element 20 may be a polarization diffraction region having polarization-dependency, for example, a polarization hologram region according to the polarization of light. Since P-polarized or S-polarized light is emitted from the semiconductor laser used as the light source 11, the optical element 20 transmits light incident on the optical disc 10 without diffraction and diffracts only light reflected by the optical disc 10 such that the light in the light region with the overlapping ±1 order light beams is prevented from being received by the photodetector 40.

When the quarter wave plate 19 is used, to increase optical efficiency, the optical pickup may include a polarization-dependent optical path changer, for example, a polarizing beam splitter 14, which changes an optical path of incident light according to polarization. In this case, the quarter wave plate 19 is disposed between the polarizing beam splitter 14 and the objective lens 30.

The polarizing beam splitter 14 directs light incident from the light source 11 toward the objective lens 30, and light reflected by the optical disc 10 toward the photodetector 40.

When the polarizing beam splitter 14 and the quarter wave plate 19 are used, first linearly polarized light, for example, P-polarized light, incident from the light source 11 on the polarizing beam splitter 14 is transmitted through a mirrored surface of the polarizing beam splitter 14 and incident on the quarter wave plate 19 to be changed into first circularly polarized light directed toward the optical disc 10. The first circularly polarized light is reflected by the optical disc 10 to become second circularly polarized light, and passes through the quarter wave plate 19 again to become second linearly polarized light, for example, S-polarized light. The second linearly polarized light is reflected by the mirror surface of the polarizing beam splitter 14 to travel toward the photodetector 40.

The polarization-dependent optical path changer may be a polarization hologram element that transmits first polarized light emitted from the light source 11 and diffracts second polarized light reflected by the optical disc 10 into +1 order light or −1 order light. In this case, the light source 11 and the photodetector 40 may be optically modularized.

Instead of the polarization-dependent optical path changer, a beam splitter to transmit and reflect incident light at a predetermined ratio may be used. Alternately, a hologram element to transmit light emitted from the light source 11 and to diffract light reflected by the optical disc 10 into +1 order light or −1 order light may also be used. When the hologram element is used as the optical path changer, the light source 11 and the photodetector 40 may be optically modularized.

As shown in FIG. 9, the photodetector 40 may comprise a quadrant photodetector having four light-receiving portions A, B, C, and D arranged in a 2×2 matrix bisected in a radial direction (R direction) and in a tangential direction (T direction) so as to detect a focus error signal FES using an astigmatic method.

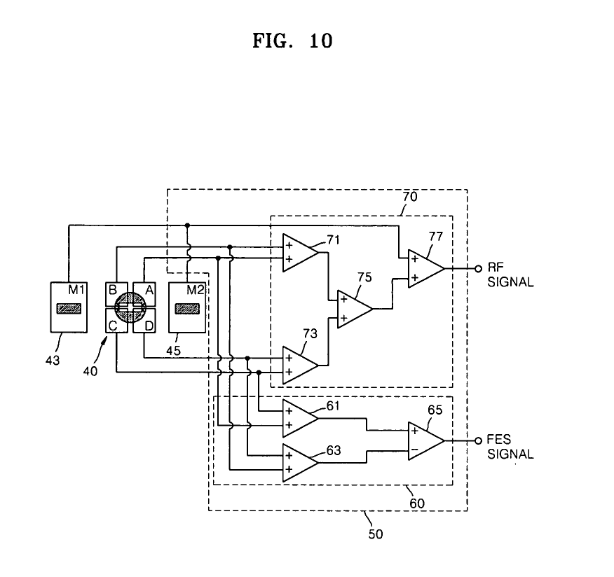

FIG. 10 illustrates a signal operational circuit 50 and an example of a photodetector of the optical pickup according to an aspect of the present invention. As shown in FIG. 10, the optical pickup may include the quadrant photodetector 40, and one or more auxiliary photodetectors 43 and 45 that receive light in the light region diffracted by the optical element 20. The two auxiliary photodetectors 43 and 45 are respectively used to receive the +1 order light and the −1 order light diffracted by the diffraction region 25 of the optical element 20.

The signal operational circuit 50 may include a reproduction signal detecting portion 70 in addition to the focus error signal detecting portion 60. The reproduction signal detecting portion 70 produces an information reproduction signal, that is, an RF signal, which is obtained by summing a signal detected by the quadrant photodetector 40 and signals detected by the auxiliary photodetectors 43 and 45.

As further shown in FIG. 10, the focus error signal detecting portion 60 may include an adder 61 to add signals detected by the two diagonal light-receiving portions A and C of the photodetector 40, an adder 63 to add signals detected by the other two light-receiving portions B and D, and a differential operator 65 to obtain a subtraction between a signal (B+D) output from the adder 63 and a signal (A+C) output from the adder 61 and to output a focus error signal (FES). The focus error signal (FES), which is output from the focus error signal detecting portion 60, may be normalized by a summed signal (A+B+C+D) that is obtained by summing the signals detected by the four light-receiving portions A, B, C, and D of the photodetector 40 together.

The reproduction signal detecting portion 70 includes an adder 71 to add signals detected by the two light-receiving portions A and B of the photodetector 40, an adder 73 to add signals detected by the light-receiving portions C and D, an adder 75 to add a signal (A+B) and a signal (C+D) output from the two adders 71 and 73, and an adder 77 to add a signal output from the adder 75 and a sum signal (M1+M2), which is obtained by summing signals Ml and M2 detected by the auxiliary photodetectors 43 and 45, and to output an RF signal.

The circuits for the focus error signal detecting portion 60 and the reproduction signal detecting portion 70 are exemplarily shown in FIG. 10, and may be modified according to various embodiments of the invention.

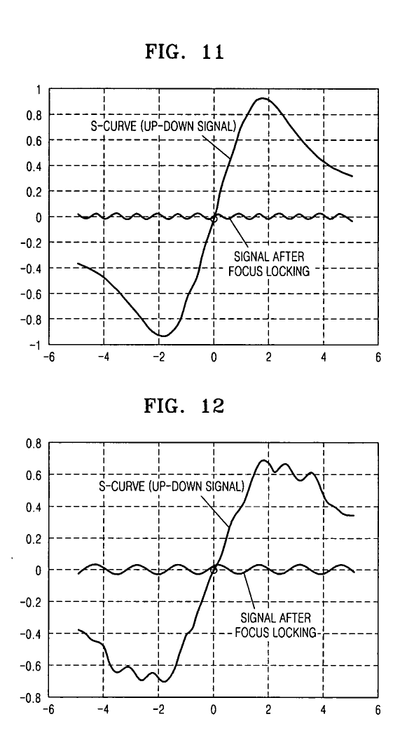

FIGS. 11 and 12 are graphs illustrating focusing signals detected by the optical pickup according to aspects of the present invention using an astigmatic method for a DVD-R/RW and a DVD-RAM. In particular, these graphs illustrate S-curves (up-down signals) that are obtained when the objective lens 30 is moved up and down and signals that are obtained when the focusing signals are locked. In FIGS. 11 and 12, the horizontal axis represents a distance between the objective lens 30 and the optical disc 10, and the vertical axis represents a focus error signal.

As shown in FIG. 11, the optical pickup, according to aspects of the present invention, detects a focus error signal of a relatively good quality even for a DVD-R/RW. Similarly, as shown in FIG. 12, the optical pickup, according to aspects of the present invention, detects a focus error signal of a relatively good quality for a DVD-RAM as well.

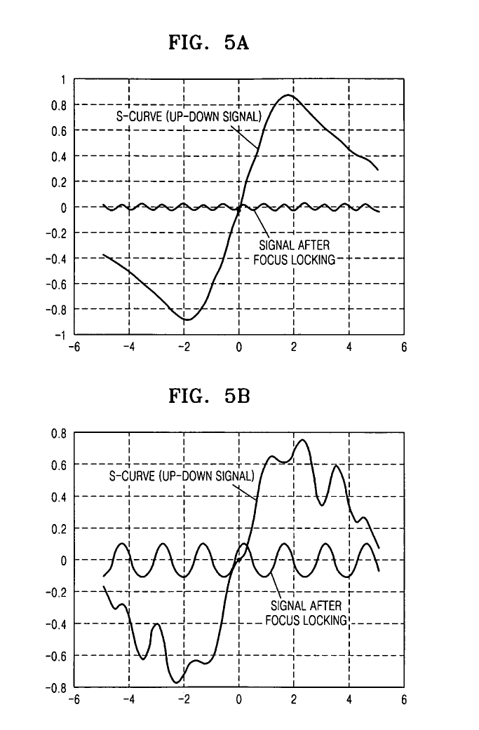

In a comparison between FIG. 5B, which illustrates focusing signals detected by a conventional optical pickup, and FIG. 12, which is illustrates focusing signals detected by the optical pickup according to an aspect of the present invention, in the case of the DVD-RAM, a ratio of an amplitude after the focus locking process to a peak-to-peak amplitude of the S-curve is shown to be improved by approximately 14% in the conventional optical pickup to approximately 4% in the present optical pickup. This is due to the fact that, in the case of the land/groove optical disc, such as the DVD-RAM or the BD, the optical pickup, according to an aspect of the present invention, produces a focus error signal from detecting signals of light removed from the light region where the ±1 order light beams overlap each other (i.e., the regions of the light beams that generate focus crosstalk).

Although FIGS. 6 and 7 show the optical pickup with a specific optical configuration, the present invention is not limited thereto. The arrangement and structure of the optical pickup, according to the present invention, may vary according to various embodiments. For example, the optical pickup may further include a grating (not shown), which divides light emitted from the light source into zero^{th} order light (main light) and ±1 order light (sub light) to detect a tracking error signal using a 3-beam method or a differential push-pull (DPP) method, and may include a sub photodetector (not shown), which receives the sub light. The sub photodetector may be divided into two parts in a radial direction to detect the tracking error signal using the DPP method.

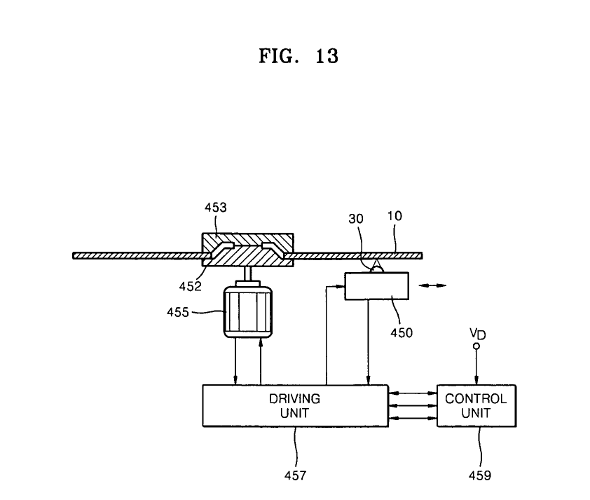

FIG. 13 illustrates an optical recording and/or reproducing apparatus employing an optical pickup according to an aspect of the present invention. As shown in FIG. 13, the optical recording and/or reproducing apparatus includes a spindle motor 455 to rotate the optical disc 10, which is the optical information storage medium, an optical pickup 450, which is movable in a radial direction of the optical disc 10 and which reproduces and/or records information onto/from the optical disc 10, a driving unit 457 to drive the spindle motor 455 and the optical pickup 450, and a control unit 459 to control focus and tracking servos of the optical pickup 450. Reference numeral 452 denotes a turntable, and reference numeral 453 denotes a clamp chucking the optical disc 10.

The optical pickup 450 may have the optical configuration according to aspects of the present invention as described above. Here, light reflected by the optical disc 10 is detected and converted into an electrical signal by the photodetector of the optical pickup 450, and the electrical signal is input to the control unit 459 through the driving unit 457. The driving unit 457 controls the rotational speed of the spindle motor 455, amplifies an input signal, and drives the optical pickup 450. The control unit 459 transmits a focus servo and/or a tracking servo command adjusted based on a signal input from the driving unit 457 to the driving unit 457 so as to enable the optical pickup 450 to perform focusing and/or tracking.

The optical recording and/or reproducing apparatus employing the optical pickup according to an aspect of the present invention detects a focus error signal with reduced focus crosstalk using an astigmatic method, even when using a land/groove optical disc in which information is recorded on both lands and grooves.

As is described above, since light of the light region where ±1 order light beams diffracted by the optical disc overlap each other is not received by the photodetector, a focus error signal is detected using an astigmatic method, even when a land/groove information storage medium is used.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical pickup, comprising:
a light source;
an objective lens to focus light emitted from the light source to form a light spot on an optical information storage medium;
an optical path changer to change an optical path of the light;
a photodetector to receive light reflected/diffracted by the optical information storage medium and to detect an information signal and/or an error signal; and
an optical element preventing part disposed in a central region of the light, to prevent a part of the central region of the light, which is reflected/diffracted by the optical information storage medium and which propagates toward the photodetector, from being received by the photodetector.

2. The optical pickup according to claim 1, wherein, when a track pitch of the optical information storage medium, which is distance between adjacent grooves, is P, the wavelength of light emitted from the light source is λ, the numerical aperture of the objective lens is NA, and the radius of an exit pupil of the objective lens is normalized to 1, the optical element prevents the light which is reflected/diffracted by the optical information storage medium and which is located at a range of approximately ±(λ/(NA*P)−1) in a direction of the reflected/diffracted light from the optical information storage medium from being received by the photodetector.

3. The optical pickup according to claim 1, wherein the optical information storage medium is selected from a group of at least first and second optical information storage media having different standards.

4. The optical pickup according to claim 3, wherein information is recorded on both lands and grooves of the first optical information storage medium and the track pitch of the first information storage medium is P1, and information is recorded only on grooves of the second optical information storage medium and the track pitch of the second information storage medium is P2, and when P1>P2, the optical element prevents light in a range of approximately ±(λ/(NA*P1)−1) from being received by the photodetector.

5. The optical pickup according to claim 1, wherein the optical element has a diffraction region that diffracts light propagating toward the photodetector so that light in part of a central region of the light deviates from the photodetector.

6. The optical pickup according to claim 5, further comprising a wave plate, interposed between the optical element and the objective lens, to change the polarization of incident light, wherein the diffraction region of the optical element is a polarization diffraction region being polarization-dependent so that the incident light, according to the polarization of the incident light, transmits toward the optical information storage medium and light reflected by the optical information storage medium diffracts.

7. The optical pickup according to claim 6, further comprising:
an astigmatic element interposed between the optical path changer and the photodetector to detect a focus error signal using an astigmatic method; and
a focus error signal detecting portion to generate a focus error signal from a signal detected by the photodetector using the astigmatic method.

8. The optical pickup according to claim 7, wherein the photodetector is a quadrant photodetector with four light-receiving portions arranged in a 2×2 matrix.

9. The optical pickup according to claim 7, wherein the optical element prevents the part of the central portion of the light from being received by the photodetector by diffracting the part of the central portion of the light, the optical pickup further comprising:
at least one auxiliary photodetector to receive the part of the central region of the light diffracted by the optical element; and
a reproduction signal detecting portion to produce an information reproduction signal as a sum of a signal detected by the photodetector and a signal detected by the auxiliary photodetector.

10. The optical pickup according to claim 1, wherein the photodetector comprises four light-receiving portions, and the optical pickup further comprises:
an astigmatic element, interposed between the optical path changer and the photodetector, to detect a focus error signal using an astigmatic method; and
a focus error signal detecting portion to produce a focus error signal from signals detected by the four light-receiving portions of the photodetector using the astigmatic method.

11. The optical pickup according to claim 10, wherein the photodetector comprises a quadrant photodetector with the four light-receiving portions arranged in a 2×2 matrix.

12. The optical pickup according to claim 10, wherein the optical element prevents the part of the central portion of the light from being received by the photodetector by diffracting the part of the central portion of the light, and the optical pickup further comprises:
at least one auxiliary photodetector to receive the part of the central region of the light diffracted by the optical element; and
a reproduction signal detecting portion producing an information reproduction signal as a sum of a signal detected by the photodetector and a signal detected by the auxiliary photodetector.

13. An optical recording and/or reproducing apparatus, comprising:
the optical pickup of claim 1, being movable in a radial direction of the optical information storage medium, to reproduce and/or record information from and/or onto the optical information storage medium; and
a control unit to control the optical pickup.

14. The optical pickup according to claim 13, wherein, when a track pitch of the optical information storage medium, which is distance between adjacent grooves, is P, the wavelength of light emitted from the light source is λ, the numerical aperture of the objective lens is NA, and the radius of an exit pupil of the objective lens is normalized to 1, the optical element prevents the light which is reflected/diffracted by the optical information storage medium and which is located at a range of approximately ±(λ/(NA*P)−1) in a direction of the reflected/diffracted light from the optical information storage medium from being received by the photodetector.

15. The optical pickup according to claim 13, wherein the optical information storage medium is selected from a group of at least first and second optical information storage media having different standards.

16. The optical pickup according to claim 15, wherein information is recorded on both lands and grooves of the first optical information storage medium and the track pitch of the first information storage medium is P1, and information is recorded only on grooves of the second optical information storage medium and the track pitch of the second information storage medium is P2, and when P1>P2, the optical element prevents light in a range of approximately ±(λ/(NA*P1)−1) from being received by the photodetector.

17. The optical pickup according to claim 13, wherein the optical element has a diffraction region that diffracts light propagating toward the photodetector so that light in part of a central region of the light deviates from the photodetector.

18. The optical pickup according to claim 17, further comprising a wave plate, interposed between the optical element and the objective lens, to change the polarization of incident light, wherein the diffraction region of the optical element is a polarization diffraction region being polarization-dependent so that the incident light, according to the polarization of the incident light, transmits toward the optical information storage medium and light reflected by the optical information storage medium diffracts.

19. The optical pickup according to claim 18, further comprising:
an astigmatic element interposed between the optical path changer and the photodetector to detect a focus error signal using an astigmatic method; and
a focus error signal detecting portion to generate a focus error signal from a signal detected by the photodetector using the astigmatic method.

20. The optical pickup according to claim 19, wherein the photodetector is a quadrant photodetector with four light-receiving portions arranged in a 2×2 matrix.

21. The optical pickup according to claim 19, wherein the optical element prevents the part of the central portion of the light from being received by the photodetector by diffracting the part of the central portion of the light, the optical pickup further comprising:
at least one auxiliary photodetector to receive the part of the central region of the light diffracted by the optical element; and
a reproduction signal detecting portion to produce an information reproduction signal as a sum of a signal detected by the photodetector and a signal detected by the auxiliary photodetector.

22. The optical pickup according to claim 13, wherein the photodetector comprises four light-receiving portions, and the optical pickup further comprises:
an astigmatic element, interposed between the optical path changer and the photodetector, to detect a focus error signal using an astigmatic method; and
a focus error signal detecting portion to produce a focus error signal from signals detected by the four light-receiving portions of the photodetector using the astigmatic method.

23. The optical pickup according to claim 22, wherein the photodetector comprises a quadrant photodetector with the four light-receiving portions arranged in a 2×2 matrix.

24. The optical pickup according to claim 22, wherein the optical element prevents the part of the central portion of the light from being received by the photodetector by diffracting the part of the central portion of the light, and the optical pickup further comprises:
at least one auxiliary photodetector to receive the part of the central region of the light diffracted by the optical element; and
a reproduction signal detecting portion producing an information reproduction signal as a sum of a signal detected by the photodetector and a signal detected by the auxiliary photodetector.

25. An optical pickup, comprising:
an objective lens to form a light spot on an optical information storage medium;
a photodetector to receive light that is reflected/diffracted from the light spot of the optical information storage medium and to detect an information signal and/or an error signal therefrom; and
an optical element to diffract a light region of the light that is reflected/diffracted from the light spot, where ±1 order light beams overlap each other such that light in the light region deviates from the photodetector.

26. The optical pickup according to claim 25, wherein the optical element comprises a diffraction region that diffracts light propagating toward the photodetector.

27. An optical recording and/or reproducing apparatus, comprising the optical pickup of claim 25, being movable in a radial direction of the optical information storage medium, to reproduce and/or record information from and/or onto the optical information storage medium, and a control unit to control the optical pickup.
